(19) United States
(12) Patent Application Publication
(10) Pub. No.: US 2002/0003470 A1
(43) Pub. Date: Jan. 10, 2002

(54) Automatic location of gunshots detected by mobile devices

(76) Inventor: Mitchell Auerbach, Melbourne, FL (US)

Correspondence Address: Mr. Mitchell Auerbach, 2496 Park Place Blvd, Melbourne, FL, 32935, US

(21) Appl. No.: 09/755,529

(22) Filed: Jan. 5, 2001

Related U.S. Application Data
(60) Provisional application No. 60/202,500, filed on May 5, 2000.
(60) Provisional application No. 60/174,818, filed on Jan. 7, 2000.
(60) Provisional application No. 60/120,096, filed on Feb. 16, 1999.
(60) Provisional application No. 60/111,281, filed on Dec. 7, 1998.

(51) Int. Cl. B60Q 1/00

(52) U.S. Cl. 340/425.5

(57) ABSTRACT

An active gunshot warning system which uses acoustic sensors mounted on moving vehicles, fixed locations, or in combination with moving vehicles and fixed locations. The sensors detect the occurrence of gunshots, and uses audio information from the gunshots in combination with a blast library to identify the type of weapon or weapons used. The sensors detect, when more than one gunshot is detected, and if the gunshots come from a stationary location or are moving. Information related to the gunshots, detailing location, direction of movement, number of shots fired, and type of weapon or weapons is automatically forwarded to police vehicles, or to the military where appropriate, to assist the authorities in their response to the gunshots. A communication and warning system is also used in combination with the gunshot protection system to define locations within the geographic area that may be at risk and to notify individuals within that geographic area of potential danger. Notification can be made via any convenient communications system such as land line telephone, cellular telephones detected within the area, pager, Internet, etc.

### CROOS-REFERENCE TO RELATED APPLICATIONS

This application is a continuation-in-part application of the commonly owned co-pending application entitled “Emergency Tracking and Notification System,” filed May 5, 2000, bearing U.S. Ser. No. 09/202,500 and naming Mitchell Auerbach, the named inventor herein, as sole inventor, the contents of which is specifically incorporated by reference herein in its entirety; the commonly owned co-pending application entitled “Automatic Location of Gunshots Detected by a Moving Vehicle,” filed Jan. 7, 2000, bearing U.S. Ser. No. 60/174,818 and naming Mitchell Auerbach, the named inventor herein, as sole inventor, the contents of which is specifically incorporated by reference herein in its entirety; the commonly owned copending application entitled “Automatic Telephone Notification of Locations in a Tornado Path,” filed Dec. 6, 1999, bearing U.S. Ser. No. 09/454,507 and naming Mitchell Auerbach, the named inventor herein, as sole inventor, the contents of which is specifically incorporated by reference herein in its entirety; and which is a continuation of the commonly owned provisional application, now expired, entitled “Automatic Telephone Notification of Locations in a Tornado Path,” filed Feb. 16, 1999, bearing U.S. Ser. No. 60/120,096 and naming Mitchell Auerbach, the named inventor herein, as sole inventor, the contents of which is specifically incorporated by reference herein in its entirety; and which is also a continuation of the commonly owned provisional application, now expired, entitled “Emergency Management Communications System,” filed Dec. 7, 1998, bearing U.S. Ser. No. 60/111,281 and naming Mitchell Auerbach, the named inventor herein, as inventor, and John Root, as an inventor, the contents of which is specifically incorporated by reference herein in its entirety.

### BACKGROUND OF THE INVENTION

1. Technical Field

The present invention relates to gunshot detection and warning systems. In particular, it relates a system for detecting explosive events, such as gunshots, and for determining their locations. More particularly, it relates to a system which uses multiple spatially separated acoustic sensors, signal processing techniques, and communications facilities to determine the location of gunshots, the type and number of weapons used, and notifies appropriate parties as to the location of the gunshots and information related to the type of weapon or weapons.

2. Background Art

Due to the amount of violence caused by gunfire, particularly in urban environments, there is a need for the police to rapidly determine when gunfire occurs and the location of such gunfire in order to arrive at the scene as quickly as possible. In addition to addressing this problem with conventional police measures, the such as radio communications, an automated computer controlled detection and response control system for responding to gunshots would be useful. In particular, the ability to quickly locate gunshots in an urban area can help quicken the response of law enforcement officials and medical rescue teams to the location of the gunfire. In addition, rapid response by the police can increase the possibility of apprehension and conviction of perpetrators.

It is known that acoustic sensing equipment using software and microphones distributed in an area suffering gunfire can be used to identity and locate gunshots. In particular, seismological software can be and has been adapted to a two-dimensional geometry for this purpose. Although prior art technology has demonstrated the scientific ability to locate urban gunfire, its capabilities do not extend to an effective system useful for law enforcement. In particular, this technology does not provide an automatic realtime determination of the gunshot locations and times, it does not have the ability to determine the type or number of weapons, it does not have an automatic alerting system for authorities, and it does not automatically indicate rapidly the gunfire location on a map to facilitate dispatching.

Another known method for detecting and reporting urban gunshot events uses a dense grid of microphones placed on utility poles at every street comer in a designated urban area. Since this type of high density grid typically requires more than 80 sensors per square mile covered, it is very expensive to deploy and maintain. As a result, this type of detection system is impractical for many localities due to its high-cost. This system uses the relative time data from reported events to perform triangulation and locate the origin of the gunshot. In addition, this system may also have difficulty in distinguishing a gunshot from other sounds.

While addressing the basic desirability of using detection equipment to assist police in the event of gunshots, the prior art has failed to provide an active warning system which can automatically detect gunshots, automatically determine the location of the gunshots, automatically determine whether the gunshots come from a single location or from a moving source, automatically determine what type of weapon or weapons are being used, and automatically provide location and targeting information for counter measures to the police, or to other entities such as the military. In addition, the prior art does not provide a system of automatically identifying areas addressed and notifying individuals in those areas about potential danger while it is simultaneously coordinating activities and providing information to police and/or other authorities.

### SUMMARY OF THE INVENTION

The present invention solves these problems by providing a system which uses acoustic sensors that can be mounted on moving vehicles, on fixed locations, or used with a combination of moving vehicles and fixed locations. The sensors detect the occurrence of gunshots, and the audio information from the detected gunshots is used in combination with a blast library to identify the type of weapon or weapons used. A blast library is a database containing the audio signatures of individual gun types. The sensors also detect, when more than one gunshot is detected, if the gunshots come from a stationary location or are moving. Information related to the gunshots which describes the location, the direction of movement, the number of shots fired, and the type of weapon or weapons is automatically forwarded to police vehicles, or to the military where appropriate, to assist the authorities in their response to the gunshots.

A communication and warning system is also used in combination with the gunshot protection system to define locations within the geographic area that may be at risk and to notify individuals within that geographic area of potential danger. Notification can be made via any convenient communications system such as land line telephone, cellular telephones detected within the area, pager, Internet, etc.

### BRIEF DESCRIPTION OF THE DRAWINGS

FIG. 1 is a diagram which illustrates the process of civilian notification using cellular telephone systems to identify cellular telephones within a gunshot danger area and to warn individuals with those cellular telephones.

FIG. 2 is a diagram which illustrates the process of commercial trucking notification using cellular telephone systems to identify cellular telephones within a gunshot danger area and to warn individuals with those cellular telephones.

FIG. 3 is a diagram which illustrates the process of individual subscriber notification using cellular telephone systems to identify subscriber devices within a gunshot danger area and to warn individuals with those subscriber devices.

FIG. 4 is a diagram which illustrates the process of individual subscriber notification using cellular telephone systems to identify vibrating subscriber devices for the disabled within a gunshot danger area and to warn individuals with those vibrating subscriber devices.

FIG. 5 is a diagram that illustrates a manually operated emergency notification device which works via the cellular telephone system. In this embodiment, an individual would carry a manually activated device which signals the cellular telephone system in an emergency. This cellular telephone system would in turn alert the appropriate authorities or emergency services.

FIG. 6 is a diagram illustrating a gunshot being detected by three mobile sensing stations mounted on police vehicles, GPS satellite data is used to triangulate the position of the gunshot, and a central computer communicates direction information and information related to the gunshots (weapon caliber, number of weapons, etc) to the police vehicles.

FIG. 7 illustrates the triangulation process on a geographic grid used by the police vehicles when a gunshot is detected.

### DESCRIPTION OF THE PREFERRED EMBODIMENT

Prior to a detailed discussion of the figures, a general overview of the features and advantages of the invention will be presented. This invention uses acoustic sensors to detect the occurrence of gunshots. A database containing a blast library is used by the system. The blast library contains the audio signatures of various weapon types and calibers. The audio information from the detected gunshots is compared with the blast library to identify the type of weapon or weapons used. The sensors also detect if more than one gunshot is detected, if the gunshots come from different types of weapons, and if the gunshots come from a stationary location or are moving.

Information related to the gunshots, detailing location, direction of movement, number of shots fired, and type of weapon or weapons is automatically forwarded to police vehicles, or to the military where appropriate, to assist the authorities in their response to the gunshots. The use of the blast library by this invention provides significant value to police officers, since they can be automatically advised by the computer as to the type and number of weapons involved. This information may have significant value, and may even save the lives of the officers, when they arrive on the scene since the information will make them aware of the dangers they face.

The information is also provided to a weapons response system which can be used to direct return fire to the gunshots. The return fire system can use any suitable weapons control system such as laser targeting, GPS based location targeting, etc. Of course, this type of return fire system would most likely be used in military actions.

A communication and warning system is also used in combination with the gunshot protection system to define locations within the geographic area that may be at risk, and to notify individuals within that geographic area of potential danger. Notification can be made via any convenient communications system such as land line telephone, cellular telephones detected within the area, pagers, television, radio, the Internet, etc.

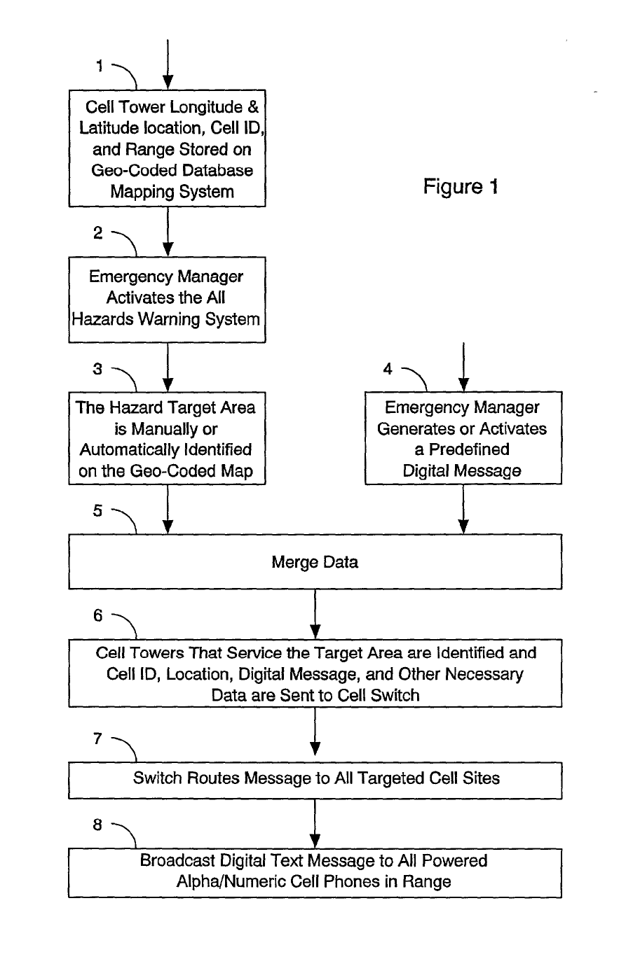

Regarding FIG. 1, this figure illustrates a digital text and voice communication system which utilizes cell towers to broadcast hazard information to any cellular telephone with an Alpha/numeric display that is powered on in the target cell area. The cell tower longitude and latitude coordinates are installed on the telephone base geo-coded map to allow for immediate access in an emergency. When the system is activated, the operator or the computer identifies the affected area on the Geo-coded map and the cell tower information is pulled up along with dedicated phone, cell, pager, and control panel numbers. All the cell towers in a potential hazard area are identified, and placed on the call list within seconds of detecting potential danger. The system has the option to apply a new real-time message or to utilize a pre-recorded scenario message. The message, Cell ID, and other required data are sent to the cell tower via T1 switching or any other suitable current or future information conveyance. Once the message reaches the tower, it is broadcast to all phones logged in to the tower with digital text capability. Since this operation is a broadcast instead of a serial callout, it is faster and more efficient than wired communications.

The steps used by FIG. 1 operate as follows:

1—Load Cell Towers on Map

The longitude and latitude of every tower in the coverage area is loaded on the geo-coded map. The coverage of each tower is also loaded as a radius which is displayed when the Cell Tower option is selected in the menu. The Cell ID code and routing information is also stored with the cell information in the map data base. The map provides for immediate access to the cell towers through a graphical interface which is applied manually or automatically by the computer depending on the hazard at hand.

2—Activate Warning System

The Emergency Manager can locally or remotely activate the call scenario that is pre-programmed for every hazardous event. Activation is accomplished by entering access codes and ID followed by the target location by drawing or selecting an object area on the map.

3—Identify Target Area

The target area is identified automatically by Nexrad Radar interfaces for severe weather, infrared Satellite for Wild Fires, Acoustical Triangulation for Gunfire, Projection Plumes for Chemical, Nuclear, and Biological hazards, and manually for any scenario in the system.

4—Assign Digital Message

The Emergency Manager can record an emergency message by phone and utilize the voice to text translator or type in the digital message at the computer. The Emergency Manager can also utilize a pre-recorded message that is stored with the particular scenario database.

5—Merge Data

The recorded message is merged with the Cell ID Code and other routing data for delivery to the routing switch or other tower delivery mechanism.

6—Identify Towers & Send Data to Switch

The software pulls the cell tower call list from the geo-coded map database with associated Codes & Routing.

7—Switch Routes Data to Target Towers

The Tower Switch or other routing mechanism reads the Tower ID codes and sends the message to the identified cell towers.

8—Towers Broadcast Message

The tower receives the digital text message with command language to “Broadcast” the message on all frequencies to send to all digital cell phones in the area.

9—Automated Notification

The Alert 911 module will provide the subscriber with the capability to press one button on a cell phone or pager which will send the location and ID code to the RESPOND 911 system indicating an emergency and activating dispatch to the location.

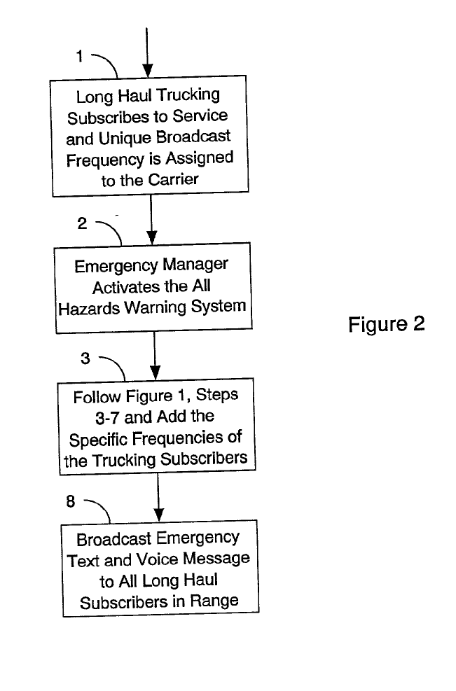

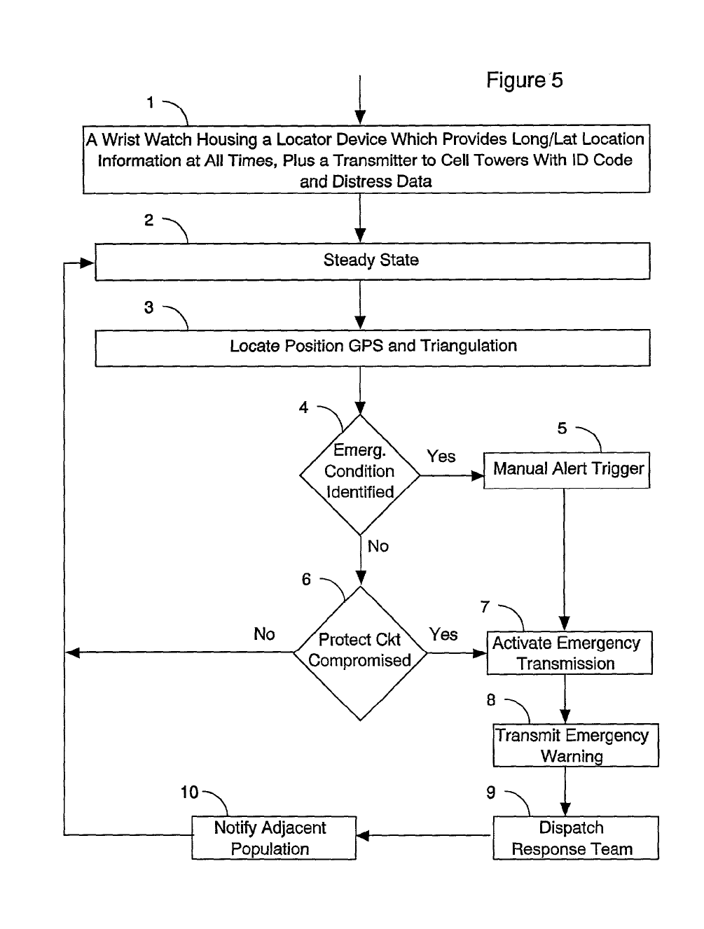

In FIG. 2, an alternative embodiment is illustrated in which, for example, a trucking company would be a subscriber to the system and the entire complement of vehicles would receive the same cellular phone number and frequency. When a hazardous event occurs, all subscriber trucking company trucks in the target area will be notified by broadcast of the digital message on their associated frequencies. The message would be sent to the cab digital text communication devices. This information can address, not only gunshot hazards, but also chemical spills, wildfire, tornado, hurricane, high wind and storm, accident delays, road hazard, and all other hazards that would affect long haul rig drivers. The system will also preferably embody the features of FIG. 5, below, which will track all of the trailers and cabs of a subscriber and identify the long/lat location of the cab and trailer on the geo-coded map. If the system detects a movement of either element after the system security module has been activated then an alarm is generated.

The steps used by FIG. 2 operate as follows:

1—Assign Number and Frequency

When subscriber signs a contract for all trucks in its long haul trucking business, a universal ID phone number is assigned the company. This will insure that all trucks will be sent the Hazards Message when in the target area. This product can be use for any fleet service other than long haul trucking.

2—Activate RESPOND Warning System

The RESPOND system is activated as in FIG. 1. above.

3—Follow steps 3-7 in FIG. 2 and Add Subscriber Frequencies

Follow the same processes as define in FIG. 1, above. In addition the frequencies (phone numbers) of the trucking companies are entered into the system from the mapping data base along with communication protocols for the particular systems installed in the cabs of the trucks or other carriers.

4—Towers Broadcast Message

The message is broadcast to all subscriber companies in the target area to their respective communication systems.

5—Locator911 and Alert911 modules

Locator and Alert will provide a tracking and Alert notification facility which will identify the location of the cab and trailer and send a manually activated or automatic message to the RESPOND911 system providing this location and advise of an emergency in progress.

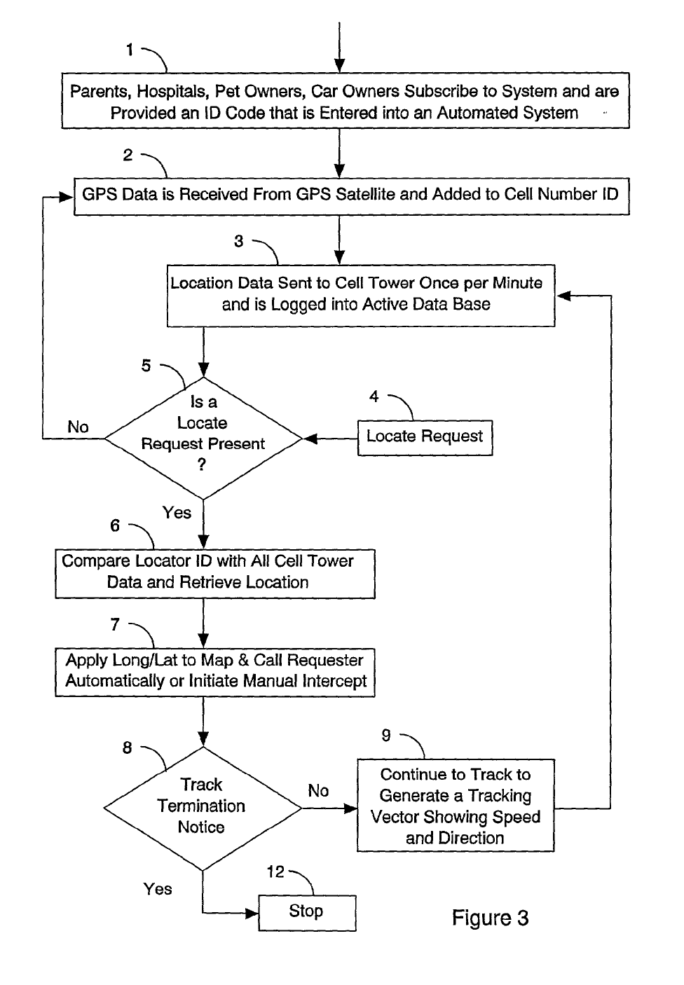

In FIG. 3, another referred embodiment of the invention is shown. In this embodiment, a GPS interface is used which identifies the location of lost children, hospital patients and those with dementia and Alzheimer's, lost animals and lost vehicles, etc. This embodiment utilizes GPS and cell tower triangulation to identify its user's location by longitude and latitude. This information is transmitted with the user ID (Phone#) to the closest cell tower. This information is transmitted once per minute as not to deplete the batteries. When a “missing request” is received at the tracking office (user ID or phone is, number), the user unit phone number is entered into the system. When a match is found between the tracking device and the “missing request” number, the reported longitude and latitude are sent to the system and applied to the Geo-coded Map. The Long/Lat plot gives the precise location. One minute updates will provide a direction and speed vector to assist in the location and pickup. This embodiment, when used in conjunction with vehicles, can also be used to control an engine cut-off switch. An automated call to the subscriber can be generated as an optional feature. The subscriber can use this feature to activate an alert device which will notify the system of an emergency such as an assault, kidnapping, loss of memory (Alzheimer), stolen vehicle, lost pet or farm animal, etc. This real time mapping will provide law enforcement and emergency management with an immediate target location for interception and/or rescue.

The steps used by FIG. 3 operate as follows:

1—Subscriber Assigned ID Phone Number & Profile

The subscriber is assigned a cell phone number (USER ID) with each locator wrist band, leg band, necklace, or other configuration of the electronics. A profile and picture is loaded in the tracking data base for fast distribution on the internet communication system.

2—GPS Data, Cell Data Plus ID Number

The locator device contains a small GPS receiver to retrieve longitude and latitude information from the GPS satellite. The locator also contains a cell transmitter which sends a ping to the cell tower once a minute with ID CODE and location data.

3—Transmit to Cell Tower

Each minute a new location and user ID is sent to the cell tower via a data packet that is universally accepted by all towers. Locations are also triangulated between cell towers as a backup to the GPS system for locating individuals or objects inside buildings where GPS is inoperative.

4—Lost Request Reported

When a child, patient, pet, or vehicle is lost, the responsible party calls the nearest Locator21 Center with the ID code of the tracking device. The tracking device can be entered by automated IVR interface or manually through an operator. Long Haul trucking will also be able to enter request information for lost cabs or trailers.

5—System Monitors for Request

The RESPOND Locator911 constantly looks for lost requests automatically and has live operators to manually receive calls and activate the appropriate dispatch scenarios.

6—Compare Cell Data to Call in Data

When a “Lost Report” is received the user ID code is entered into the system as identified above and an immediate compare to cell site databases is activated. When an ID code match is detected the longitude/latitude data is taken from the cell data base code and displayed on the geo-coded map that matches that location. The geo-coded map also contains phone and cell numbers of all residents and businesses in the area. A circle, polygon, or other suitable shape could be drawn around the missing person or vehicle and all residents could be automatically notified of the loss and asked to assist in the search or investigation as needed.

7—Integrate Location Data with Map and Notify

The closest address, street, city, county, and state is interpreted from the map. The location is provided to the responsible party by voice, text to voice, and to pre-defined internet address. The picture and other profile data can be immediately sent to local law enforcement for identification and recovery.

8—Check for Track Termination

If the track is not terminated, the system enters a tracking loop that will continue unless a termination command is received either manually or through a time out mechanism.

9—Track for Vector Positioning

As the system cycles at one minute iterations, a direction vector can be generated with speed and location so that law enforcement can set an intercept target and find the child, patient, per, and or vehicle.

10—Recycle Process

Retrieve location data until termination.

11 Terminate Process

End tracking and initialize system.

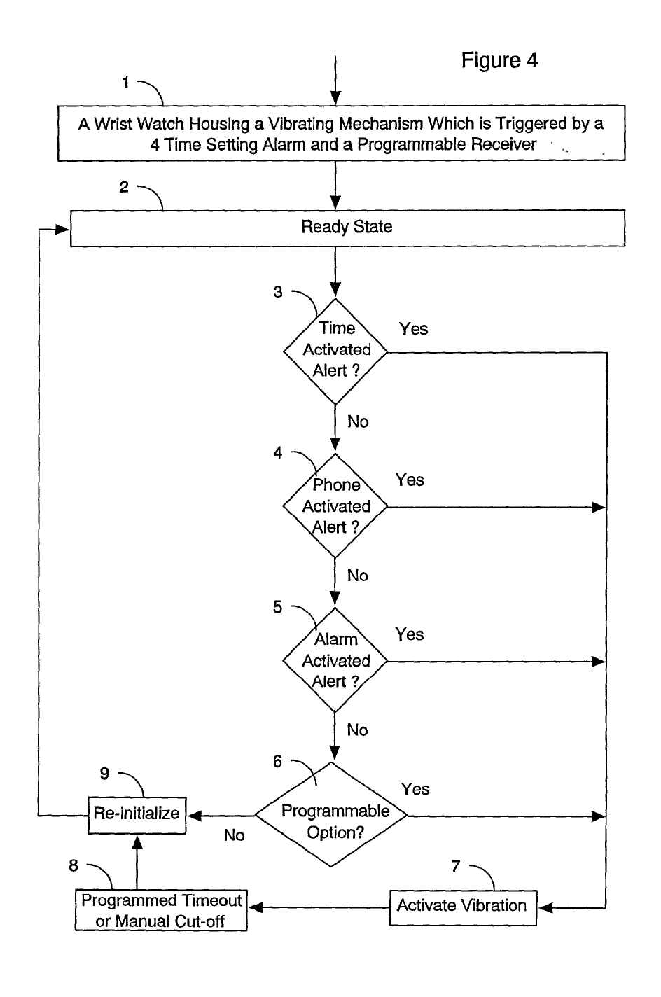

In FIG. 4, another alternative embodiment is shown in which a notification unit for the elderly and hearing impaired community and others who require special notification of hazardous events or have to take special action to avoid emergencies. This embodiment will vibrate when the phone rings, a smoke or other detector activates, or upon reaching any of the time settings for taking medication or any other required action. It can be programmed to vibrate to almost any event which is identified by a wireless signal in the range of the system. The uses of this wireless notification system are unlimited. The notification module will attach to a communication device to provide the subscriber with a direct communication with 911 services in the event of an emergency.

The steps used by FIG. 4 operate as follows:

1—Set Frequency for Use Option

Set watch options for Phone Detect, Alarm Detect, Time Reminders, or optional notification or any/all of the above. The provider would make these adjustments at the point of sale.

2—Initialize to Ready

Clear all registers and watch processors; Activate the Alert911 option for emergency notification

3—Time Activated Alert Option

Activate Vibrator at all of four time alerts

4—Phone Activated Alert Option

Activate Vibrator when phone rings

5—Alarm Activated Alert Option

Activate Vibrator On Smoke Alarm or other Alarm

6—Customized Option

Activate Vibrator when option alert criteria is met

7—Activate Vibrator

Any signal that is programmed into the device can be made to activate the vibrator.

8—Acfivate Alert911

The subscriber simply presses the alarm activation switch and a signal is sent to the RESPOND 911 system for servicing. This cell platformed automated 911 call would contain location, ID code, and time of emergency. Medical records of the subscriber could be accessed by the RESPOND medical internet module.

9—Time out or Cut-off

The vibration can be manually terminated by a cut-off button or automatically terminated by a programmed time out.

10—Re-initialize

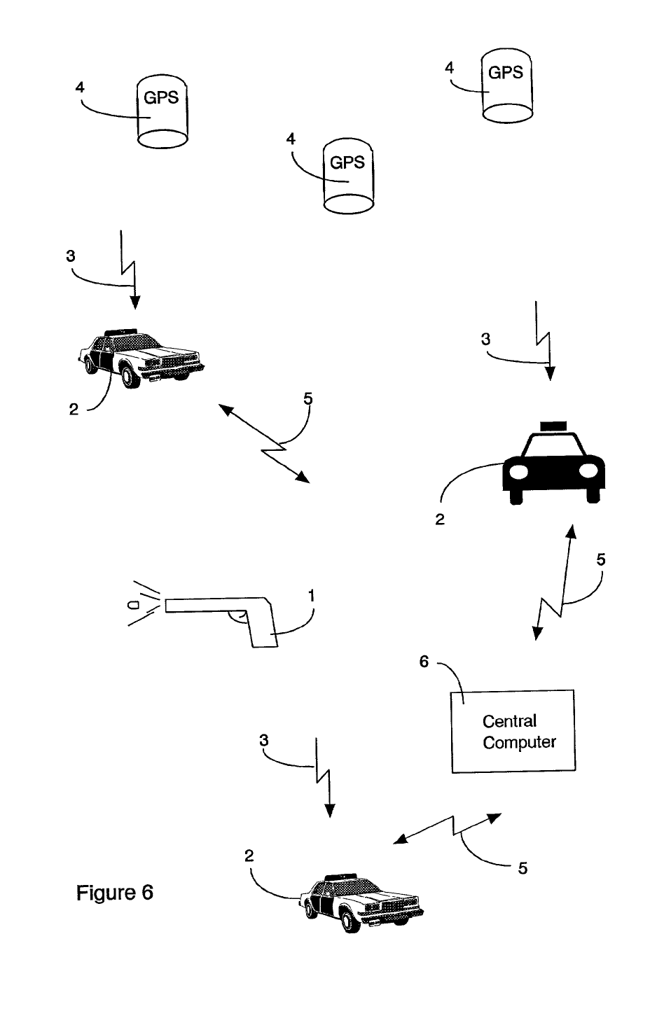

Clear all processor registers and go to standby awaiting next activation signal. Regarding FIG. 5, FIG. 5 illustrates an emergency notification device which works via the cell tower system to send an emergency alert signal to the computer 6 (shown below in regard to FIG. 6) which contains the long/lat (GPS) location of the emergency event and the ID code and mobile access number of the police vehicle, individual, property or vehicle under protection. This device works in conjunction with any suitable land line or wireless devices. This device can be manually activated by an individual or automatically activated by computer 6.

Referring to FIG. 6, in this figure, each police vehicle 2 using this system will have a directional audio detection system capable of determining if a firearm 1 has been discharged. In addition, the audio detection system is capable of determining the direction from which the sound of the firearm 1 discharge came from.

As soon as the police vehicle 1 detects the discharge of a firearm 1, it activates an on-board GPS receiver (not shown) which receives GPS positioning information signals 3 from GPS satellites 4. Using this position information, the exact location of the police vehicle 2 is known. Each police vehicle 2 then transmits the data describing the location of the police vehicle 2 and the direction of the firearm 1 discharge in relation to that police vehicle 2. The data is transmitted via wireless link 5 to a central computer 6. The nature of the transmission medium can be any suitable wireless communication medium, such as cellular modem, radio, etc.

The central computer 6, after receiving the position and direction information from each police vehicle 2 then determines the location of the firearm 1 discharge via known triangulation techniques.

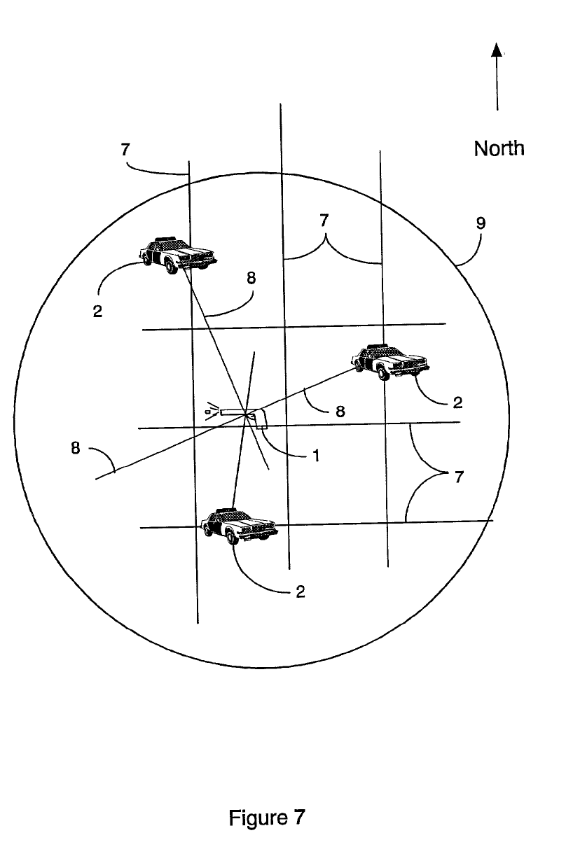

FIG. 7 illustrates the location of police vehicles 2 on city streets 7. Lines 8 indicate the triangulation lines calculated by the central computer 6. The central computer 6 pinpoints the longitude and latitude on the geo-coded map located on the central computer 6 and transmits this location to the similar remote computers located in police cars in the protected community. Longitude, latitude, street address, zip code, property owner, and phone number information is sent to the police vehicle. Since the audible muzzle blast is recorded, the sound file can be played to the dispatched officers so that they will be aware of the type of weapons being utilized by the perpetrator. Likewise, the computer 6 can automatically determine type and number of weapons used by comparing the audio signatures from the gunshots to the gunshot signatures contained in the blast database. The police vehicles 2 can then proceed directly to the location of the shooting with the advantage that they have information related to the nature of the event and the type of weapons being used. Having knowledge of the weapons they are confronting prior to arrival may mean the difference between life and death for the police officer.

The central computer 6 can transmit a graphic image to each police vehicle 2 which is graphically displayed on a computer terminal in the police vehicle 2 and which illustrates location data for the gunshots. In addition, the central computer 6 can also send additional data, such as longitudinal and latitudinal data, zip code data, and approximate street addresses. Also, the computer 6 can add a radial distance indicator such as that shown by circle 9 so that the police know the approximate range where the perpetrator may be.

By having this data automatically and instantaneously produced by a computerized system without requiring intervention by an individual, the police will be alerted more rapidly and potentially be able to arrive at the scene of a crime before the perpetrator has had a chance to escape, and also, to arrive at the scene of a crime earlier so that more effective aid can begin to a victim.

Sound maps of all known weapons are loaded into central computer 6 in the form of a blast library. The perpetrator weapon sound map can be compared to entries in the blast library to identify the type of gun, caliber, fire rate, and any other useful information which will better prepare the office to meet the threat. Due to the speed of the system, the officer in the patrol car can be notified of the event prior to any 911 calls coming in from the general public.

To further assist the police officer and protect the community, the central computer 6 can activate a call-out to the residents in the target area by simply drawing a polygon on the geo-coded map to pull phone and cell numbers from the map in a matter of seconds. The entire neighborhood can be notified of the danger and residents can be queried for pertinent information in a few minutes. This notification and feedback information will help save the lives of police officers and general public alike. If the perpetrator fires shots while moving, the central computer 6 will generate a vector direction and notif police of the direction and latest position of the perpetrator. The appropriate areas of the community will be notified as the perpetrator moves through the city. The central computer 6 will also automatically mobilize the appropriate police response team both in vehicles and in management positions via cell, land line, pager, satellite, internet and all other suitable types of communication media. A gunshot tracking map can be displayed on the central computer 6 internet communication systems. This information can be immediately sent to local radio and TV stations to advise the general public to avoid the target area.

If a controlled response is indicated as in the case of an armed bank robbery, a terrorist attack, a drug firefight, or a military action, the central computer 6 will direct laser guided or geo-coded weapons to return fire and eliminate snipers and other armed perpetrators which are deemed highly dangerous and must be removed in a short time frame. Directional cameras can be mounted on the tracking systems to record the events for later criminal prosecution along with the audible evidence of the gunfire.

Once the location of the firearm discharge has been identified an option to return fire utilizing a laser guided automatic rifle, missile launcher, directed energy weapon, or other neutralizing weapon, can be activated targeting the geographic location of the target. It is known that fixed monitoring stations capable of detecting the discharge of a firearm can be placed on buildings, towers etc.. However, such fixed stations are prone to vandalism and may be objected to by the people who live in a neighborhood where stations are located. Existing technology must be connected by phone line to a central computer which makes the relocation of the receiving device tedious and expensive if not impossible. This invention provides a mobile firearm detection system where the reception devices can be moved in real time either in a moving vehicle or placed in a new location at any time to redefine a periphery of coverage.

This invention provides a mobile firearm detection and response system in which mobile detectors, mapping computers, and optional counter measure weapons are carried within police vehicles or mounted on alternate attack vehicles or fixed launch sites.

While the invention has been described with respect to a preferred embodiment thereof, it will be understood by those skilled in the art that various changes in detail may be made therein without departing from the spirit, scope, and teaching of the invention. Accordingly, the invention herein disclosed is to be limited only as specified in the following claims.

I claim:

1. A gunshot warning and response system, further comprising:
a mobile acoustic sensing system having means to detect gunshots;
means to determine the geographic coordinates of the gunshots; and
needs to notify police and coordinate interception of the perpetrator;
whereby the location of gunshots can be detected by moving vehicles interception can be automatically coordinated.
